(19) United States
(12) Patent Application Publication
(10) Pub. No.: US 2026/0170886 A1
(43) Pub. Date: Jun. 18, 2026

(54) CAR WASH CYCLE OPTIMIZATION DEVICE AND METHOD

(71) Applicants: HYUNDAI MOTOR COMPANY, SEOUL (KR); KIA CORPORATION, SEOUL (KR)

(72) Inventors: Jeawan Kim, Hwaseong-si (KR); Jungmo Yu, Hwaseong-si (KR)

(73) Assignees: HYUNDAI MOTOR COMPANY, SEOUL (KR); KIA CORPORATION, SEOUL (KR)

(21) Appl. No.: 19/280,630

(22) Filed: Jul. 25, 2025

(30) Foreign Application Priority Data
Dec. 13, 2024 (KR) 10-2024-0185593

(51) Int. Cl. G07C 5/04; G01C 21/34; G06Q 10/1093

(52) U.S. Cl. CPC G07C 5/04; G01C 21/3484; G06Q 10/1093

(57) ABSTRACT

A car wash cycle optimization method includes collecting vehicle operation information and weather information from an integrated database, determining whether car washing is necessary based on the vehicle operation information, determining whether car washing is possible based on the weather information, and generating a car wash schedule and providing a driver with a location of and a route to a driver’s preferred car wash together with the car wash schedule when car washing is necessary and possible.

### CROSS REFERENCE TO RELATED APPLICATIONS

This application claims priority to and the benefit of Korean Patent Application No. 10-2024-0185593 filed with the Korean Intellectual Property Office on December 13, 2024, the entire contents of which are incorporated herein by reference.

### BACKGROUND

### (a) Field

The present disclosure relates to a car wash cycle optimization device and method, and more particularly, to a car wash cycle optimization device and method that provides a driver-tailored car wash schedule based on weather and operation information.

### (b) Description of the Related Art

When a driver decides that a vehicle needs to be washed and looks for a place for car washing, the driver puts efforts into searching for a car wash that fits a car wash type corresponding to customer’s tendencies, such as a mechanical car wash, a self-service car wash, or a business operator’s manual car wash.

When the driver finds a place for car washing, the driver goes there. If there are many vehicles waiting, the driver may have to wait for a long time. After washing the car, the car has become clean, but it may rain with dust the next day. In this case, the car wash becomes useless and the driver has to schedule another car wash.

Therefore, there is a demand for an idea capable of saving the customer’s time/cost by reducing the time taken for the customer to find a place for car washing, letting the customer know in advance how long the customer will have to wait for car washing, and automatically taking weather forecast for the day after the desired car wash schedule.

### SUMMARY

The present disclosure attempts to provide a car wash cycle optimization device and method capable of determining whether a vehicle currently needs to be washed, reasonably determining whether car washing is actually possible based on data such as a vehicle driving record, weather while the vehicle is driving, and a weather forecast, and if possible, suggesting a location/route of/to a place for car washing that suits customer’s tendencies.

An embodiment of the present disclosure provides a car wash cycle optimization method including collecting vehicle operation information and weather information from an integrated database, determining whether car washing is necessary based on the vehicle operation information, determining whether car washing is possible based on the weather information, and generating a car wash schedule and providing a driver with a location of and a route to a driver’s preferred car wash together with the car wash schedule when car washing is necessary and possible.

The car wash cycle optimization method may further include providing the car wash schedule to car wash-related business operators including the driver’s preferred car wash when the driver has consented.

The determining of whether car washing is necessary may include determining whether car washing is necessary based on whether the vehicle has been driven outside on a rainy, snowy, or dusty day since the vehicle was last washed, while referring to the weather information.

The determining of whether car washing is necessary based on whether the vehicle has been driven outside on the rainy, snowy, or dusty day since the vehicle was last washed may include determining weather information, vehicle driving information, and information on whether wipers have operated from a detection sensor after a last car wash date, and determining that car washing is necessary when the weather information includes rain, snow, or dust, when the vehicle driving information includes driving information more than or equal to a specific period of time or driving information more than or equal to a specific distance, or when there is information indicating that the wipers have operated after the last car wash date from the detection sensor.

The determining of whether car washing is possible may include determining whether car washing is possible based on a vehicle driving history after a last car wash, current weather information, and weather forecast data for a certain period of time.

The determining of whether car washing is possible may further include determining at least one specific date among a plurality of dates after the date on which it is determined that car washing is necessary as a date on which car washing is possible and reflect the determined date in the car wash schedule, when weather does not include rain, snow, or dust for a certain period of time after the determined date.

The providing of the location of and the route to the driver’s preferred car wash may include determining at least one driver’s preferred car wash among a plurality of car washes based on driver information including driver’s tendencies, car wash information, places stored in a navigation system of the vehicle, and vehicle GPS data.

The determining of the at least one driver’s preferred car wash among the plurality of car washes may include determining at least one preferred car wash type among a plurality of car wash types including a mechanical brush car wash, a mechanical brushless car wash, a self-service car wash, and a professional car wash based on the driver information; and finally determining at least one car wash having a user review score more than or equal to a certain standard among a plurality of car washes of the determined at least one preferred car wash type as the driver’s preferred car wash.

The providing of the location of and the route to the driver’s preferred car wash may further include when the driver does not input a destination to the navigation system, guiding the driver to a nearest driver’s preferred car wash based on GPS information, or when the driver inputs a destination to the navigation system, guiding the driver to a nearest driver’s preferred car wash on a route to the input destination.

The providing of the location of and the route to the driver’s preferred car wash may further include providing a location of and a route to a specific car wash most recently selected by the driver among car washes of types different from the preferred car wash type set according to driver’s tendencies as a second-priority option, and when the specific car wash is selected by the driver a certain number of times, providing the location of and the route to the specific car wash as a first-priority option and storing the specific car wash as the driver’s preferred car wash.

Another embodiment of the present disclosure provides a car wash cycle optimization device for optimizing a car wash cycle based on vehicle operation information and weather information stored in a driver’s vehicle or an integrated database by executing program codes loaded on one or more memory devices through one or more processors, in which the program codes are executed to collect the vehicle operation information and the weather information from the integrated database, determine whether car washing is necessary based on the vehicle operation information, determine whether car washing is possible based on the weather information, and generate a car wash schedule and providing a driver with a location of and a route to a driver’s preferred car wash together with the car wash schedule when car washing is necessary and possible.

The program codes may be further executed to provide the car wash schedule to car wash-related business operators including the driver’s preferred car wash when the driver has consented.

The determining of whether car washing is necessary based on the vehicle operation information may include determining whether car washing is necessary based on whether the vehicle has been driven outside on a rainy, snowy, or dusty day since the vehicle was last washed, while referring to the weather information.

The determining of whether car washing is necessary based on whether the vehicle has been driven outside on the rainy, snowy, or dusty day since the vehicle was last washed may include determining weather information, vehicle driving information, and information on whether wipers have operated from a detection sensor after a last car wash date, and determining that car washing is necessary when the weather information includes rain, snow, or dust, when the vehicle driving information includes driving information more than or equal to a specific period of time or driving information more than or equal to a specific distance, or when there is information indicating that the wipers have operated after the last car wash date from the detection sensor.

The determining of whether car washing is possible based on the weather information may include determining whether car washing is possible based on a vehicle driving history after a last car wash, current weather information, and weather forecast data for a certain period of time.

The determining of whether car washing is possible based on the weather information may further include determining at least one specific date among a plurality of dates after the date on which it is determined that car washing is necessary as a date on which car washing is possible and reflect the determined date in the car wash schedule, when weather does not include rain, snow, or dust for a certain period of time after the determined date.

The providing of the driver with the location of and the route to the driver’s preferred car wash may include determining at least one driver’s preferred car wash among a plurality of car washes based on driver information including driver’s tendencies, car wash information, places stored in a navigation system of the vehicle, and vehicle GPS data.

The determining of the at least one driver’s preferred car wash among the plurality of car washes may include determining at least one preferred car wash type among a plurality of car wash types including a mechanical brush car wash, a mechanical brushless car wash, a self-service car wash, and a professional car wash based on the driver information; and finally determining at least one car wash having a user review score more than or equal to a certain standard among a plurality of car washes of the determined at least one preferred car wash type as the driver’s preferred car wash.

The providing of the driver with the location of and the route to the driver’s preferred car wash may further include when the driver does not input a destination to the navigation system, guiding the driver to a nearest driver’s preferred car wash based on GPS information, or when the driver inputs a destination to the navigation system, guiding the driver to a nearest driver’s preferred car wash on a route to the input destination.

The providing of the driver with the location of and the route to the driver’s preferred car wash may further include providing a location of and a route to a specific car wash most recently selected by the driver among car washes of types different from the preferred car wash type set according to driver’s tendencies as a second-priority option, and when the specific car wash is selected by the driver a certain number of times, providing the location of and the route to the specific car wash as a first-priority option and storing the specific car wash as the driver’s preferred car wash.

The car wash cycle optimization device and method according to an embodiment of the present disclosure is capable of saving the driver’s cost and time, by determining whether the vehicle currently needs to be washed, reasonably determining whether car washing is actually possible based on data such as a vehicle driving record, weather while the vehicle is driving, and a weather forecast, and if possible, suggesting a location/route of/to a place for car washing that suits customer’s tendencies.

### BRIEF DESCRIPTION OF THE FIGURES

FIG. 1 schematically shows a car wash cycle optimization system according to an embodiment of the present disclosure.

FIG. 2 is a block diagram of a car wash cycle optimization device according to an embodiment of the present disclosure.

FIG. 3 is a flowchart of a car wash cycle optimization method according to an embodiment of the present disclosure.

FIGS. 4, 5, and FIG. 6 are flowcharts for the car wash cycle optimization method according to an embodiment of the present disclosure.

FIG. 7 is a diagram for explaining a computing device according to an embodiment of the present disclosure.

### DETAILED DESCRIPTION

Hereinafter, embodiments of the present disclosure will be described in detail with reference to the accompanying drawings, so that they can be easily carried out by those having ordinary knowledge in the art to which the present disclosure pertains. However, the present disclosure may be implemented in various different forms, and is not limited to the exemplary embodiments described herein. In order to clearly explain the present disclosure, parts irrelevant to the description will be omitted from the drawings, and like parts will be denoted by like reference numerals throughout the specification.

Throughout the specification and the claims, when a certain part is referred to as “including” a certain component, this implies the presence of other components, not precluding the presence of other components, unless explicitly stated to the contrary. Terms including ordinal numbers such as “first” and “second” may be used to describe various components, but these components are not limited by such terms. Such terms are used only for the purpose of distinguishing one component from another component.

The terms “unit”, “-er(or)”, “module”, and the like used herein may refer to a unit capable of performing at least one function or operation described herein, which may be implemented by hardware or circuitry, software, or a combination of hardware or circuitry and software.

Hereinafter, embodiments of the present disclosure will be described with reference to the drawings.

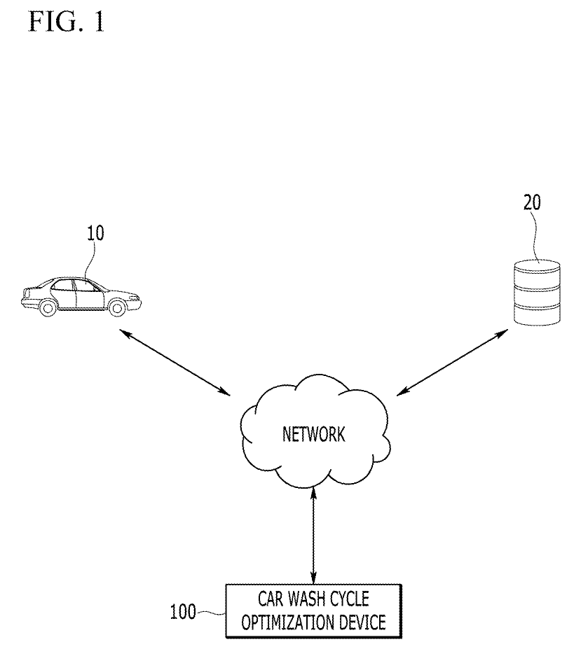

FIG. 1 schematically shows a car wash cycle optimization system according to an exemplary embodiment of the present disclosure.

Referring to FIG. 1, the car wash cycle optimization system includes a driver’s vehicle 10, an integrated database 20, and a car wash cycle optimization device 100.

The driver’s vehicle 10, the integrated database 20, and the car wash cycle optimization device 100 may be connected to each other via a wired/wireless network.

The driver’s vehicle 10 may provide vehicle information including vehicle specification information, vehicle driving information, a vehicle speed, a driving distance, and the like through a central communication unit (CCU).

The vehicle information may include sensor information detected by a sensor of a vehicle during driving or parking, as well as the driving information including a date, weather, a distance, and a speed related to driving.

The driver’s vehicle 10 may provide the vehicle information to the integrated database 20 for storage. Alternatively, the driver’s vehicle 10 may directly transmit the vehicle information to the car wash cycle optimization device 100.

The integrated database 20 stores integrated data including vehicle information collected from the vehicle and weather information or meteorological information received from a public institution or the like.

Although it is illustrated that the integrated database 20 and the car wash cycle optimization device 100, which are separated from each other, are connected to each other via the network, the integrated database 20 may be included in the car wash cycle optimization device 100, or the car wash cycle optimization device 100 may be included in the integrated database 20.

The car wash cycle optimization device 100 may receive various information including the vehicle information and the weather information from the driver’s vehicle 10 and/or the integrated database 20, determine whether the vehicle needs to be washed or whether car washing is possible based on the received information, and generate a car wash schedule including a car wash date and a place for car washing.

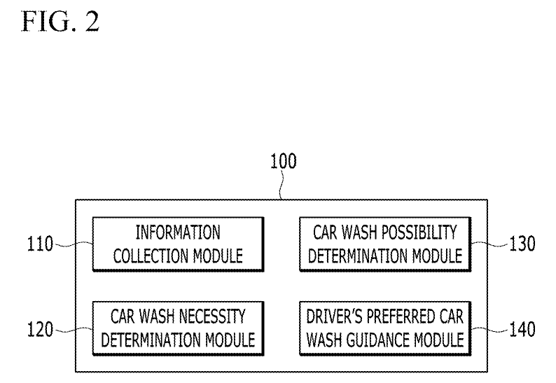

FIG. 2 is a block diagram of a car wash cycle optimization device according to an exemplary embodiment of the present disclosure.

Referring to FIG. 2, the car wash cycle optimization device 100 according to an exemplary embodiment may execute program codes or instructions loaded in one or more memory devices through one or more processors.

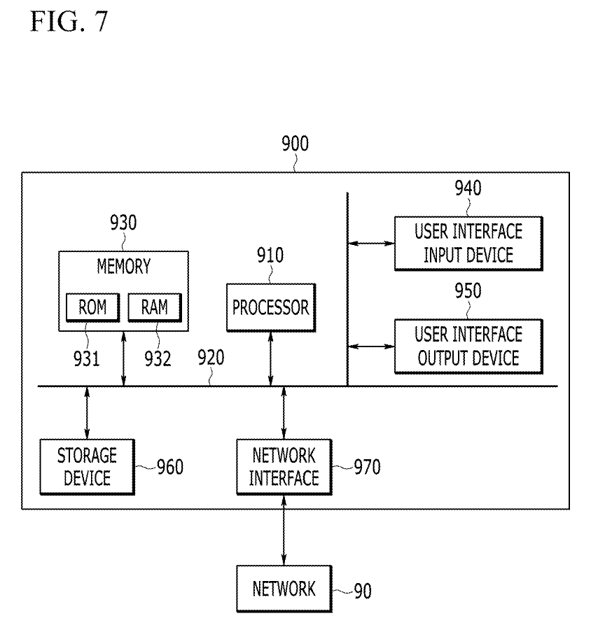

For example, the car wash cycle optimization device 100 may be implemented by a computing device 900 as will be described below with reference to FIG. 7. In this case, the one or more processors may correspond to a processor 910 of the computing device 900, and the one or more memory devices may correspond to a memory 930 of the computing device 900.

The program codes or instructions may be executed by the one or more processors to optimize a car wash cycle of the vehicle based on vehicle operation information and weather information stored in the driver’s vehicle or the integrated database.

Herein, the term “module” is used to logically separate multiple functions performed by the program codes or instructions.

Referring to FIG. 2, the car wash cycle optimization device 100 may include an information collection module 110, a car wash necessity determination module 120, a car wash possibility determination module 130, and a driver’s preferred car wash guidance module 140.

The information collection module 110 may collect vehicle operation information and weather information from the integrated database 20 (see FIG. 1).

The information collection module 110 may collect vehicle operation information through the integrated database 20 or the CCU of the driver’s vehicle 10.

The information collection module 110 may also collect weather information from the integrated database 20 or a public data server of a public institution.

The car wash necessity determination module 120 may determine whether car washing is necessary based on the vehicle operation information.

The car wash necessity determination module 120 may determine whether car washing is necessary based on whether the vehicle has been driven outside on a rainy, snowy, or dusty day since the vehicle was last washed, while referring to weather information.

The car wash necessity determination module 120 may determine weather information, vehicle driving information, and information on whether wipers have operated from a detection sensor after a last car wash date.

The car wash necessity determination module 120 may determine that car washing is necessary when the weather information includes rain, snow, or dust, when the vehicle information includes driving information more than or equal to a specific period of time or driving information more than or equal to a specific distance, or when there is information indicating that the wipers have operated after the last car wash date from the detection sensor.

The car wash possibility determination module 130 may determine whether car washing is possible based on weather information.

The car wash possibility determination module 130 may determine whether car washing is possible based on a vehicle driving history after the last car wash, current weather information, and weather forecast data for a certain period of time.

The car wash possibility determination module 130 may determine at least one specific date among a plurality of dates after the date on which it is determined that car washing is necessary as a date on which car washing is possible and reflect the determined date in the car wash schedule, when the weather does not include rain, snow, or dust for a certain period of time after the determined date.

The driver’s preferred car wash guidance module 140 may create a car wash schedule and provide the driver with a location of and a route to a driver’s preferred car wash together with the car wash schedule, when car washing is necessary and possible.

The driver’s preferred car wash guidance module 140 may determine at least one driver’s preferred car wash among a plurality of car washes based on driver information including driver’s tendencies, car wash information, places stored in a navigation system of the vehicle, and vehicle GPS data.

The driver’s preferred car wash guidance module 140 may determine at least one preferred car wash type among a plurality of car wash types including a mechanical brush car wash, a mechanical brushless car wash, a self-service car wash, and a professional car wash based on the driver information.

The driver’s preferred car wash guidance module 140 may finally determine at least one car wash having a user review score more than or equal to a certain standard among a plurality of car washes of the determined at least one preferred car wash type as a driver’s preferred car wash.

When the driver does not input a destination to the navigation system, the driver’s preferred car wash guidance module 140 may guide the driver to the nearest driver’s preferred car wash based on GPS information.

When the driver inputs a destination to the navigation system, the driver’s preferred car wash guidance module 140 may guide the driver to the nearest driver’s preferred car wash on the route to the input destination.

The driver’s preferred car wash guidance module 140 may provide a location of and a route to a specific car wash most recently selected by the driver among car washes of types different from the preferred car wash type set according to the driver’s tendencies as a second-priority option.

When a specific car wash is selected by the driver a certain number of times, the driver’s preferred car wash guidance module 140 may provide a location of and a route to the specific car wash as a first-priority option and store the specific car wash as a driver’s preferred car wash.

In an embodiment, the car wash cycle optimization device 100 may provide the car wash schedule to car wash-related business operators including the driver's preferred car wash when the driver has consented.

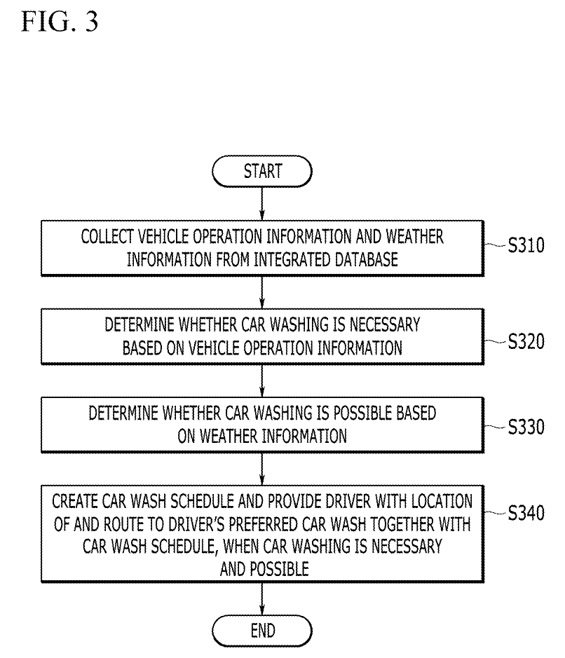

FIG. 3 is a flowchart of a car wash cycle optimization method according to an exemplary embodiment of the present disclosure. The car wash cycle optimization method of FIG. 3 may be performed by the car wash cycle optimization device 100 of FIG. 1.

In FIG. 3, the car wash cycle optimization device 100 may collect vehicle operation information and weather information from the integrated database (step S310).

The vehicle operation information includes driving information including vehicle sensor information, a driving date, a driving distance, and a driving speed.

Weather information includes weather and meteorological information for past, present and future dates.

Alternatively, the car wash cycle optimization device 100 may receive vehicle operation information from the driver’s vehicle and weather information from a public institution server.

The car wash cycle optimization device 100 may determine whether car washing is necessary based on the vehicle operation information (step S320).

The car wash cycle optimization device 100 may determine whether car washing is necessary based on whether the vehicle has been driven outside on a rainy, snowy, or dusty day since the vehicle was last washed, while referring to the weather information.

The car wash cycle optimization device 100 may determine weather information, vehicle driving information, and information on whether wipers have operated from a detection sensor after a last car wash date.

The car wash cycle optimization device 100 may determine that car washing is necessary when the weather information includes rain, snow, or dust, when the vehicle information includes driving information more than or equal to a specific period of time or driving information more than or equal to a specific distance, or when there is information indicating that the wipers have operated after the last car wash date from the detection sensor.

The car wash cycle optimization device 100 may determine whether car washing is possible based on the weather information (step S330).

The car wash cycle optimization device 100 may determine whether car washing is possible based on a vehicle driving history after the last car wash, current weather information, and weather forecast data for a certain period of time.

The car wash cycle optimization device 100 may determine at least one specific date among a plurality of dates after the date on which it is determined that car washing is necessary as a date on which car washing is possible and reflect the determined date in the car wash schedule, when the weather does not include rain, snow, or dust for a certain period of time after the determined date.

The car wash cycle optimization device 100 may provide notifications about whether car washing is necessary, whether car washing is possible, and the car wash schedule through an infotainment system of the driver’s vehicle 10 or an application of a driver’s terminal.

The car wash cycle optimization device 100 may create a car wash schedule and provide the driver with a location of and a route to a driver’s preferred car wash together with the car wash schedule, when car washing is necessary and possible (step S340).

The car wash cycle optimization device 100 may determine at least one driver’s preferred car wash among a plurality of car washes based on driver information including driver’s tendencies, car wash information, places stored in a navigation system of the vehicle, and vehicle GPS data.

The car wash cycle optimization device 100 may determine at least one preferred car wash type among a plurality of car wash types including a mechanical brush car wash, a mechanical brushless car wash, a self-service car wash, and a professional car wash based on the driver information.

The car wash cycle optimization device 100 may finally determine at least one car wash having a user review score more than or equal to a certain standard among a plurality of car washes of the determined at least one preferred car wash type as a driver’s preferred car wash.

When the driver does not input a destination to the navigation system, the car wash cycle optimization device 100 may guide the driver to the nearest driver’s preferred car wash based on GPS information.

When the driver inputs a destination to the navigation system, the car wash cycle optimization device 100 may guide the driver to the nearest driver’s preferred car wash on the route to the input destination.

The car wash cycle optimization device 100 may provide a location of and a route to a specific car wash most recently selected by the driver among car washes of types different from the preferred car wash type set according to the driver’s tendencies as a second-priority option.

When the specific car wash is selected by the driver a certain number of times, the car wash cycle optimization device 100 may provide a location of and a route to the specific car wash as a first-priority option and store the specific car wash as a driver’s preferred car wash.

The car wash cycle optimization device 100 may provide the car wash schedule to car wash-related business operators including the driver's preferred car wash when the driver has consented.

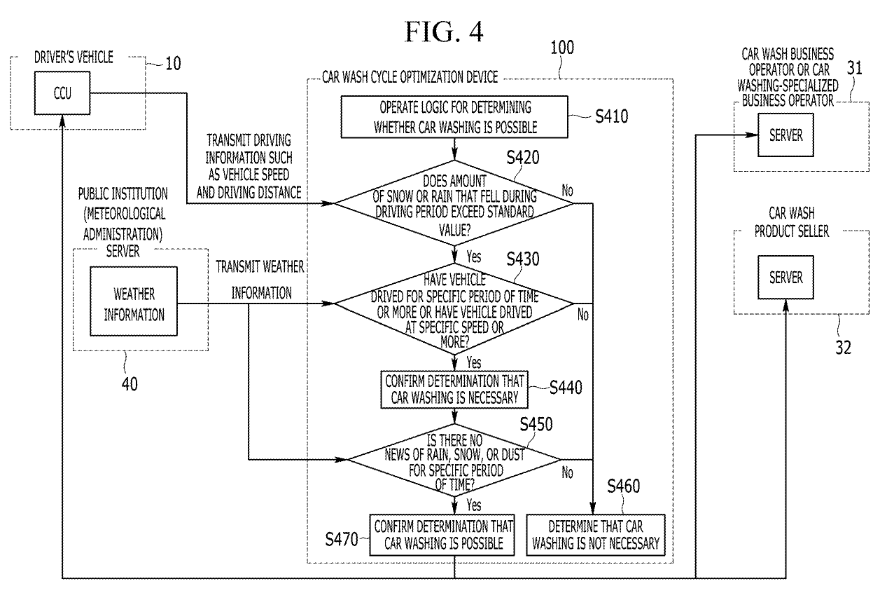

FIGS. 4 to 6 are flowcharts for the car wash cycle optimization method according to an exemplary embodiment of the present disclosure. The car wash cycle optimization method of FIGS. 4 to 6 may be performed through the car wash cycle optimization device 100 (see FIG. 1).

FIG. 4 shows a logic for confirming a determination as to whether car washing is possible according to an embodiment.

In FIG. 4, the car wash cycle optimization device 100 may start operating the logic for determining whether car washing is possible (step S410), receive driving information including a vehicle speed and a driving distance from the CCU of the driver’s vehicle 10, and receive weather information from the public institution server 40.

Alternatively, the car wash cycle optimization device 100 may receive driving information and weather information through the integrated database 20 (see FIG. 1).

The car wash cycle optimization device 100 may determine whether the amount of snow or rain that fell during a driving period included in the driving information exceeds a standard value based on the weather information (step S420).

The car wash cycle optimization device 100 may determine that car washing is not necessary when the amount of snow or rain during the driving period does not exceed the standard value (step S460).

The car wash cycle optimization device 100 may determine whether the vehicle has driven for a specific period of time or more or whether the vehicle has driven at a specific speed or more when the amount of snow or rain during the driving period exceeds the standard value (step S430).

For example, the car wash cycle optimization device 100 determines whether the amount of snow or rain exceeds the standard value based on precipitation from the weather information.

When the amount of snow or rain exceeds the standard value, the car wash cycle optimization device 100 may determine that the vehicle is contaminated enough to require car washing, for example, if the driving time is 10 hours or more or the average driving speed is 80 km/h or more based on a driving record of the driver’s vehicle 10 on a snowy or rainy day.

In this case, the car wash cycle optimization device 100 confirm a determination that car washing is necessary (step S440).

When it is determined that car washing is necessary, the car wash cycle optimization device 100 checks whether there is no news of rain, snow, or dust in a weather forecast for a specific period of time thereafter based on the weather information (step S450).

The car wash cycle optimization device 100 determines that car washing is not necessary when there is news of rain, snow, or dust in the weather forecast for the specific period of time (step S460).

The car wash cycle optimization device 100 may determine that car washing is possible when there is no news of rain, snow, or dust in the weather forecast for the specific period of time (step S470).

When it is determined that car washing is possible, the car wash cycle optimization device 100 may provide the information to the driver’s vehicle 10 through the CCU and notify the driver through the infotainment system.

When it is determined that car washing is possible, the car wash cycle optimization device 100 may provide the information to a car wash business operator 31 and a car wash product seller 32.

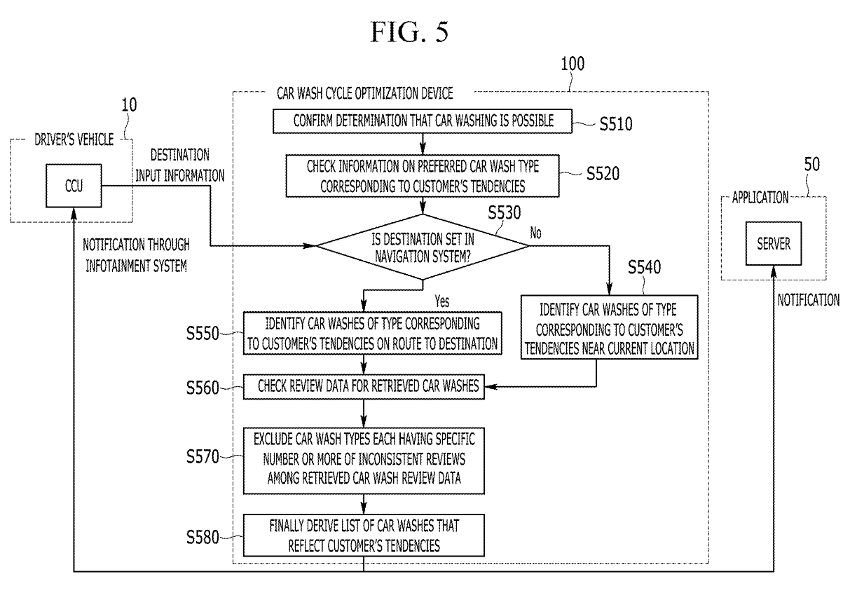

FIG. 5 shows a logic for finally determining a driver’s preferred car wash according to an exemplary embodiment.

In FIG. 5, after providing the information indicating that car washing is possible to the driver’s vehicle 10 and notifying the driver through infotainment system, the car wash cycle optimization device 100 confirms the determination that car washing is possible (step S510).

When the determination that car wash is possible is confirmed, the car wash cycle optimization device 100 checks information on a customer’s preferred car wash (step S520).

That is, the car wash cycle optimization device 100 may check a preferred car wash type according to customer’s tendencies through the integrated database or the driver’s vehicle.

The car wash cycle optimization device 100 checks whether there is a destination input from the driver’s vehicle 10 based on whether the destination is set in the navigation system (step S530).

When no destination is set in the navigation system, the car wash cycle optimization device 100 retrieves nearby driver’s preferred car washes based on a current location (step S540).

When a destination is set in the navigation system, the car wash cycle optimization device 100 may retrieve driver’s preferred car washes on a route to the destination (step S550).

The car wash cycle optimization device 100 may check review data for the retrieved car washes (step S560). The review data may be checked through data stored in the integrated database.

The car wash cycle optimization device 100 may exclude, from the retrieved driver’s preferred car washes, car washes each having a certain number or more of reviews that are actually inconsistent with the driver’s preferred car wash type among retrieved car wash review data (step S570).

The car wash cycle optimization device 100 may finally generate a list of remaining driver’s preferred car washes that reflect the driver’s (customer’s) tendencies (step S580).

The car wash cycle optimization device 100 may provide the driver’s preferred car wash list to the infotainment system of the driver’s vehicle 10 and an application 50 of the driver’s terminal.

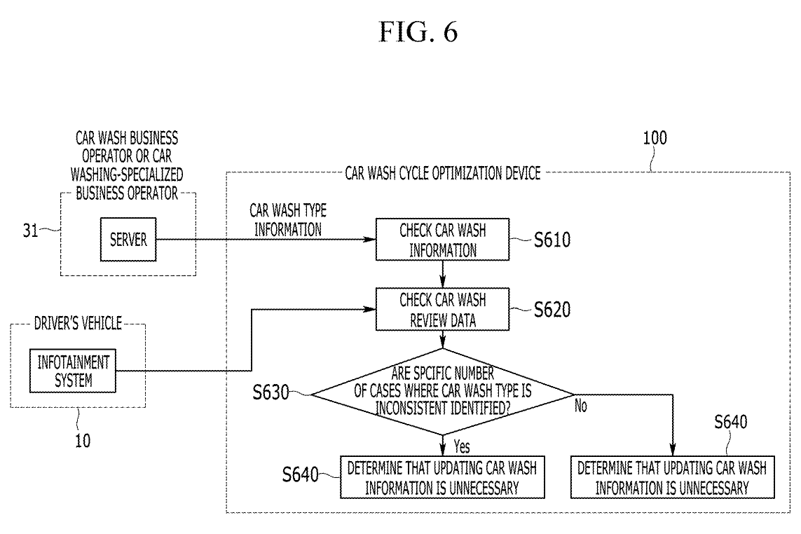

FIG. 6 is a flowchart showing a method for updating car wash information according to an exemplary embodiment.

In FIG. 6, the car wash cycle optimization device 100 may receive car wash type information from the server of the car wash business operator 31. Alternatively, the car wash cycle optimization device 100 may collect car wash type information stored in advance in the integrated database 20 (see FIG. 1).

The car wash cycle optimization device 100 may check car wash information (step S610).

The car wash cycle optimization device 100 may check car wash review data collected through the infotainment system of the driver’s vehicle 10 (step S620).

When the driver inputs a survey received from the car wash business operator 31 through the infotainment system of the driver’s vehicle after using a car wash, car wash review data for the car wash business operator is generated.

The car wash cycle optimization device 100 may receive and check the car wash review data generated in the driver’s vehicle 10.

The car wash cycle optimization device 100 determines whether a specific number or more of cases where types of car washes in the driver’s preferred car wash list are actually inconsistent with the driver’s preferred car wash type are identified through the car wash review data (step S630).

When a specific number of cases where the car wash type is inconsistent are not identified, the car wash cycle optimization device 100 determines that updating car wash information is unnecessary (step S640).

When a specific number of cases where the car wash type is inconsistent are identified, the car wash cycle optimization device 100 updates car wash information (step S650).

FIG. 7 is a diagram for explaining a computing device according to an exemplary embodiment of the present disclosure.

Referring to FIG. 7, the car wash cycle optimization devices and methods according to exemplary embodiments may be implemented using a computing device 900.

The computing device 900 may include at least one of a processor 910, a memory 930, a user interface input device 940, a user interface output device 950, and a storage device 960, which communicates with each other through a bus 920. The computing device 900 may also include a network interface 970 electrically connected to a network 90. The network interface 970 may transmit or receive signals to or from other entities via the network 90.

The processor 910 may be implemented in various types such as a micro controller unit (MCU), an application processor (AP), a central processing unit (CPU), a graphic processing unit (GPU), and a natural processing unit (NPU), and may be any semiconductor device that executes commands stored in the memory 930 or the storage device 960. The processor 910 may be configured to implement the above-described functions and methods described above with respect to FIGS. 1 to 6.

The memory 930 and the storage device 960 may include various types of volatile or non-volatile storage media. For example, the memory may include a read-only memory (ROM) 931 and a random access memory (RAM) 932. In the present exemplary embodiment, the memory 930 may be located inside or outside the processor 910, and the memory 930 may be connected to the processor 910 through various known means.

In some embodiments, at least some of the configurations or functions of the car wash cycle optimization devices and methods according to the exemplary embodiments may be implemented by programs or software executed by the computing device 900, and the programs or software may be stored in a computer-readable medium.

In some embodiments, at least some of the configurations or functions of the car wash cycle optimization devices and methods according to the exemplary embodiments according to the exemplary embodiments may be implemented using hardware or circuitry of the computing device 900, or may be implemented by separate hardware or circuitry that may be electrically connected to the computing device 900.

Although the embodiments of the present disclosure have been described in detail above, the scope of the present disclosure is not limited thereto, and various modifications and improvements made by those having ordinary knowledge in the art to which the present disclosure pertains using the basic concept of the present disclosure defined in the following claims also fall within the scope of the present disclosure.

1. A car wash cycle optimization method comprising:
collecting, by a processor, vehicle operation information and weather information from an integrated database;
determining whether car washing is necessary based on the vehicle operation information;
determining whether car washing is possible based on the weather information; and
generating a car wash schedule and providing a driver with a location of and a route to a preferred car wash of the driver together with the car wash schedule when car washing is necessary and possible.

2. The car wash cycle optimization method of claim 1, further comprising:
when the driver approves, providing the car wash schedule to car wash-related business operators including the preferred car wash.

3. The car wash cycle optimization method of claim 1, wherein the determining of whether car washing is necessary includes:
determining whether car washing is necessary based on whether the vehicle has been driven outside on a rainy, snowy, or dusty day since the vehicle was last washed, using the weather information.

4. The car wash cycle optimization method of claim 3, wherein the determining of whether car washing is necessary based on whether the vehicle has been driven outside on the rainy, snowy, or dusty day since the vehicle was last washed includes:
determining weather information, vehicle driving information, and information on whether wipers have operated from a detection sensor after a last car wash date; and
determining that car washing is necessary when the weather information includes rain, snow, or dust, when the vehicle driving information includes driving information more than or equal to a specific period of time or driving information more than or equal to a specific distance, or when it is detected that the wipers have operated after the last car wash date from the detection sensor.

5. The car wash cycle optimization method of claim 1, wherein the determining of whether car washing is possible includes:
determining whether car washing is possible based on a vehicle driving history after a last car wash, current weather information, and weather forecast data for a period of time.

6. The car wash cycle optimization method of claim 5, wherein the determining of whether car washing is possible further includes:
determining at least one date among a plurality of dates after a date on which it is determined that car washing is necessary as a date on which car washing is possible, and including the determined date in the car wash schedule when weather does not include rain, snow, or dust for a period of time after the determined date.

7. The car wash cycle optimization method of claim 1, wherein the providing of the location of and the route to the preferred car wash of the driver includes:
determining at least one preferred car wash of the driver among a plurality of car washes based on driver information including driver’s tendencies, car wash information, places stored in a navigation system of the vehicle, and vehicle GPS data.

8. The car wash cycle optimization method of claim 7, wherein the determining of the at least one preferred car wash of the driver among the plurality of car washes includes:
determining at least one preferred car wash type among a plurality of car wash types including a mechanical brush car wash, a mechanical brushless car wash, a self-service car wash, and a professional car wash based on the driver information; and
determining at least one car wash having a user review score more than or equal to a predetermined standard among a plurality of car washes of the determined at least one preferred car wash type as the preferred car wash of the driver.

9. The car wash cycle optimization method of claim 8, wherein the providing of the location of and the route to the preferred car wash of the driver further includes:
when the driver does not input a destination to the navigation system, guiding the driver to a nearest preferred car wash of the driver based on GPS information; or
when the driver inputs a destination to the navigation system, guiding the driver to a nearest preferred car wash of the driver on a route to the input destination.

10. The car wash cycle optimization method of claim 9, wherein the providing of the location of and the route to the preferred car wash of the driver further includes:
providing a location of and a route to a specific car wash most recently selected by the driver among car washes of types different from the preferred car wash type set according to driver’s tendencies as a second-priority option; and
when the specific car wash is selected by the driver a certain number of times, providing the location of and the route to the specific car wash as a first-priority option and storing the specific car wash as the preferred car wash of the driver.

11. A car wash cycle optimization device comprising:
a memory storing computer-executable instructions; and
at least one processor configured to access the memory and execute the instructions, wherein the instructions comprise:
collecting vehicle operation information and weather information from an integrated database;
determining whether car washing is necessary based on the vehicle operation information;
determining whether car washing is possible based on the weather information; and
generating a car wash schedule and providing a driver with a location of and a route to a preferred car wash of the driver together with the car wash schedule when car washing is necessary and possible.

12. The car wash cycle optimization device of claim 11, wherein the instructions further comprise, when the driver approves, providing the car wash schedule to car wash-related business operators including the preferred car wash of the driver.

13. The car wash cycle optimization device of claim 11, wherein the determining of whether car washing is necessary based on the vehicle operation information includes:
determining whether car washing is necessary based on whether the vehicle has been driven outside on a rainy, snowy, or dusty day since the vehicle was last washed, using the weather information.

14. The car wash cycle optimization device of claim 13, wherein the determining of whether car washing is necessary based on whether the vehicle has been driven outside on the rainy, snowy, or dusty day since the vehicle was last washed includes:
determining weather information, vehicle driving information, and information on whether wipers have operated from a detection sensor after a last car wash date; and
determining that car washing is necessary when the weather information includes rain, snow, or dust, when the vehicle driving information includes driving information more than or equal to a specific period of time or driving information more than or equal to a specific distance, or when it is detected that the wipers have operated after the last car wash date from the detection sensor.

15. The car wash cycle optimization device of claim 11, wherein the determining of whether car washing is possible based on the weather information includes:
determining whether car washing is possible based on a vehicle driving history after a last car wash, current weather information, and weather forecast data for a period of time.

16. The car wash cycle optimization device of claim 15, wherein the determining of whether car washing is possible based on the weather information further includes:
determining at least one specific date among a plurality of dates after the date on which it is determined that car washing is necessary as a date on which car washing is possible, and including the determined date in the car wash schedule, when weather does not include rain, snow, or dust for a period of time after the determined date.

17. The car wash cycle optimization device of claim 11, wherein the providing of the driver with the location of and the route to the preferred car wash of the driver includes:
determining at least one preferred car wash of the driver among a plurality of car washes based on driver information including driver’s tendencies, car wash information, places stored in a navigation system of the vehicle, and vehicle GPS data.

18. The car wash cycle optimization device of claim 17, wherein the determining of the at least one preferred car wash of the driver among the plurality of car washes includes:
determining at least one preferred car wash type among a plurality of car wash types including a mechanical brush car wash, a mechanical brushless car wash, a self-service car wash, and a professional car wash based on the driver information; and
determining at least one car wash having a user review score more than or equal to a predetermined standard among a plurality of car washes of the determined at least one preferred car wash type as the preferred car wash of the driver.

19. The car wash cycle optimization device of claim 18, wherein the providing of the driver with the location of and the route to the preferred car wash of the driver further includes:
when the driver does not input a destination to the navigation system, guiding the driver to a nearest preferred car wash of the driver based on GPS information; or
when the driver inputs a destination to the navigation system, guiding the driver to a nearest preferred car wash of the driver on a route to the input destination.

20. The car wash cycle optimization device of claim 19, wherein the providing of the driver with the location of and the route to the preferred car wash of the driver further includes:
providing a location of and a route to a specific car wash most recently selected by the driver among car washes of types different from the preferred car wash type set according to driver’s tendencies as a second-priority option; and
when the specific car wash is selected by the driver a predetermined number of times, providing the location of and the route to the specific car wash as a first-priority option and storing the specific car wash as the preferred car wash of the driver.
